(19) United States
(12) Patent Application Publication
(10) Pub. No.: US 2005/0036549 A1
(43) Pub. Date: Feb. 17, 2005

(54) Method and apparatus for selection of scanning mode in dual pass encoding

(76) Inventors: Yong He, San Diego, CA (US); Siu-Wai Wu, San Diego, CA (US)

Correspondence Address: Kin-Wah Tong, Esq.;Moser, Patterson & Sheridan, LLP, Suite 100, 595 Shrewsbury Avenue, Shrewsbury, NJ, 07702, US

(21) Appl. No.: 10/888,268

(22) Filed: Jul. 9, 2004

Related U.S. Application Data
(60) Provisional application No. 60/494,515, filed on Aug. 12, 2003.

(51) Int. Cl. H04N 7/12

(52) U.S. Cl. 375/240.12; 375/240.24

(57) ABSTRACT

The present invention discloses a system and method for adaptive selection of scanning modes based on the content of the input image sequence. In one embodiment, two encoders are employed. A first encoder receives the input image sequence and encodes each frame of the image sequence using at least two different scanning modes, e.g., zigzag scanning mode or alternative scanning mode in accordance with the MPEG-2 standard or the like. Specifically, different portions of each frame will be scanned using different scanning modes. This first encoding provides look-ahead information so that a second encoder is able to assign DCT quantized coefficients in a more efficient scanning order, thereby reducing encoding bits and/or improving the picture quality.

### BACKGROUND OF THE INVENTION

1. Field of the Invention

Embodiments of the present invention generally relate to an encoding system. More specifically, the present invention relates to a dual pass encoding system where scanning mode can be adaptively selected.

2. Description of the Related Art

Demands for lower bit-rates and higher video quality requires efficient use of bandwidth. To achieve these goals, the Moving Picture Experts Group (MPEG) created the Moving Picture Experts Group (MPEG) created the ISO/IEC international Standards 11172 (1991) (generally referred to as MPEG-1 format) and 13818 (1995) (generally referred to as MPEG-2 format), which are incorporated herein in their entirety by reference. One goal of these standards is to establish a standard coding/decoding strategy with sufficient flexibility to accommodate a plurality of different applications and services such as desktop video publishing, video telephone, video conferencing, digital storage media and television broadcast. Although the MPEG standards specify a general coding methodology and syntax for generating a MPEG compliant bitstream, many variations are permitted in the values assigned to many of the parameters, thereby supporting a broad range of applications and interoperability. In effect, MPEG does not define a specific algorithm needed to produce a valid bitstream. Furthermore, MPEG encoder designers are accorded great flexibility in developing and implementing their own MPEG-specific algorithms in areas such as image pre-processing, motion estimation, coding mode decisions, scalability, rate control and scan mode decisions. However, a common goal of MPEG encoder designers is to minimize subjective distortion for a prescribed bit rate and operating delay constraint.

In the area of scan mode decisions, the quantized Discrete Cosine Transform (“DCT”) block can be scanned in several different scanning modes, e.g., zigzag or alternative order, to facilitate the subsequent run-length encoding. Depending on the video content presented, one scanning mode may produce a better compression efficiency than another scanning mode or vice versa.

To illustrate, in the MPEG-2 standard, there is a one-bit flag to signal DCT scan mode in the header of every picture. Once the scan mode is selected, the entire picture has to use the same DCT scan mode. However, the vertical correlation and horizontal correlation of pixels varies from frame to frame.

Some encoders use the frame/field motion prediction mode to determine the DCT scan mode, e.g., zigzag scan is selected if the frame is coded as frame prediction (e.g. film) or alternative scan is chosen for normal interlaced video. However, sometimes the best frame/field motion prediction mode may not produce the best DCT scan mode. For example, a still image of vertical lines is better compressed with frame prediction and zigzag DCT scan, whereas a still image of horizontal lines is better compressed with frame prediction and alternative DCT scan.

Thus, there is a need in the art for an encoding system and method that can select the proper scanning mode to achieve better compression efficiency while maintaining or improving picture quality.

### SUMMARY OF THE INVENTION

In one embodiment, the present invention discloses a system and method for adaptive selection of scanning modes based on the content of the input image sequence. Namely, content-adaptive scanning mode selection is able to assign DCT quantized coefficients in a more efficient scanning order, thereby reducing encoding bits and improving the picture quality.

In one embodiment, two encoders are employed. A first encoder receives the input image sequence and encodes each frame of the image sequence using at least two different scanning modes, e.g., zigzag scanning mode or alternative scanning mode in accordance with the MPEG-2 standard or the like. Specifically, different portions of each frame will be scanned using different scanning modes.

For example, the different portions may comprise slices of macroblocks, macroblocks, or subblocks within the macroblocks and so on. To illustrate, a picture having 480 rows can be divided into 30 slices of macroblocks. Odd slices of macroblocks will be encoded using a first scanning mode, e.g., the zigzag scanning mode, while even slices of macroblocks will be encoded using a second scanning mode, e.g., the alternative scanning mode. Once each frame is encoded, the encoder will be able to determine which scanning mode actually will be more efficient and/or will improve picture quality. This information is provided to a second encoder that will be able to adaptively select the proper scanning mode to actually encode the input image sequence. By using the appropriate DCT scan pattern, the second pass encoder is able to achieve better encoding efficiency on each individual frame or picture.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a dual pass encoding system of the present invention;

FIG. 2 illustrates a motion compensated encoder of the present invention;

FIG. 3 illustrates a zigzag scanning pattern;

FIG. 4 illustrates an alternative scanning pattern in accordance with MPEG-2;

FIG. 5 illustrates a method for adaptive selection of scanning modes based on the content of the input image sequence of the present invention; and

FIG. 6 illustrates the present invention implemented using a general purpose computer.

To facilitate understanding, identical reference numerals have been used, wherever possible, to designate identical elements that are common to the figures.

### DETAILED DESCRIPTION OF THE PREFERRED EMBODIMENT

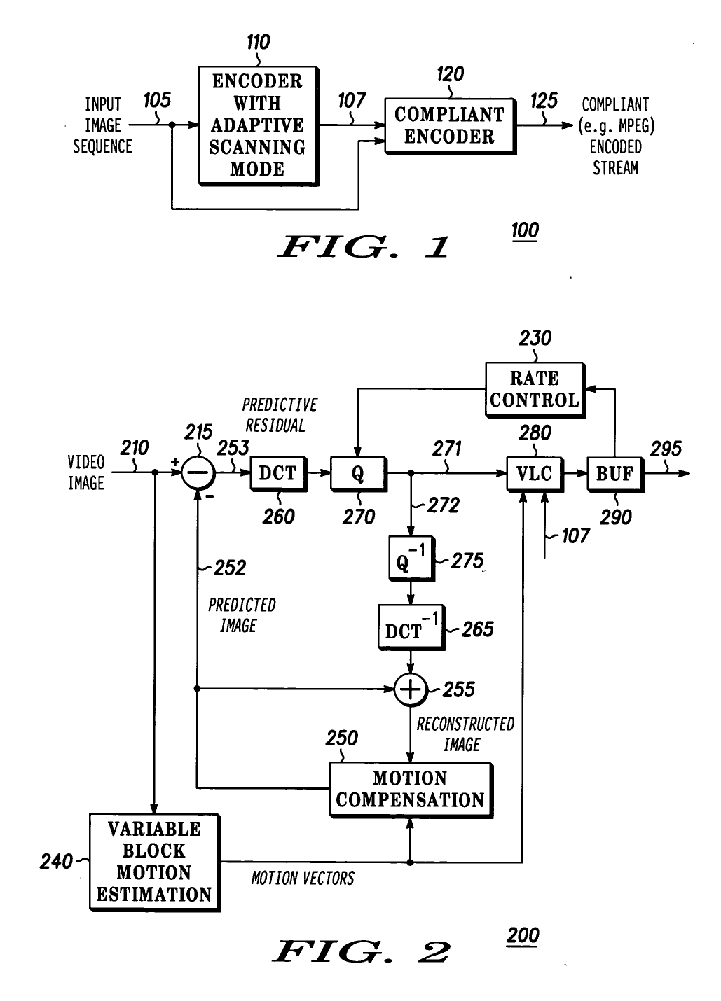

FIG. 1 illustrates a dual pass encoding system 100 of the present invention. The dual pass encoding system 100 comprises a first encoder 110 and a second encoder 120. In operation, the first encoder 110 implements adaptive scanning mode encoding where each picture within the input image sequence on path 105 is encoding using at least two scanning modes. The resulting encoding efficiency information (e.g., the number of encoding bits used for each scanning mode) for each frame based on the at least two scanning modes is then provided to the second encoder 120. In turn, the second encoder 120 is now provided with the information to allow it to select the proper scanning mode to actually encode the input image sequence 105 into a compliant (e.g., MPEG-compliant) encoded stream on path 125.

It should be noted that the first encoder 110 need not be a compliant encoder, e.g., an MPEG encoder. The reason is that the image sequence is actually not being encoded into the final compliant encoded stream by the first encoder. The main purpose of the first encoder is to apply different scanning modes to each image within the input image sequence. For example, odd slices within each pictures are scanned using the zigzag scanning mode (shown in FIG. 3) whereas even slices within each pictures are scanned using the alternative scanning mode (shown in FIG. 4). The efficiency and/or quality of the encoded image can be easily determined based upon the result of each of the selected scanning modes, e.g., comparing the efficiency of odd slices with even slices. In turn, this information on path 107 can be effectively exploited by the second encoder to properly select the scanning mode to actually encode the image sequence. Thus, the first encoder can be a non-compliant encoder or a compliant encoder, whereas the second encoder is a compliant encoder.

It should be noted that although the present invention is described within the context of MPEG-2, the present invention is not so limited. Namely, the compliant encoder can be an MPEG-2 compliant encoder or an encoder that is compliant to any other compression standards, e.g., MPEG-4, H.261, H.263 and so on. In other words, the present invention can be applied to any other compression standards that allow multiple scanning mode decisions.

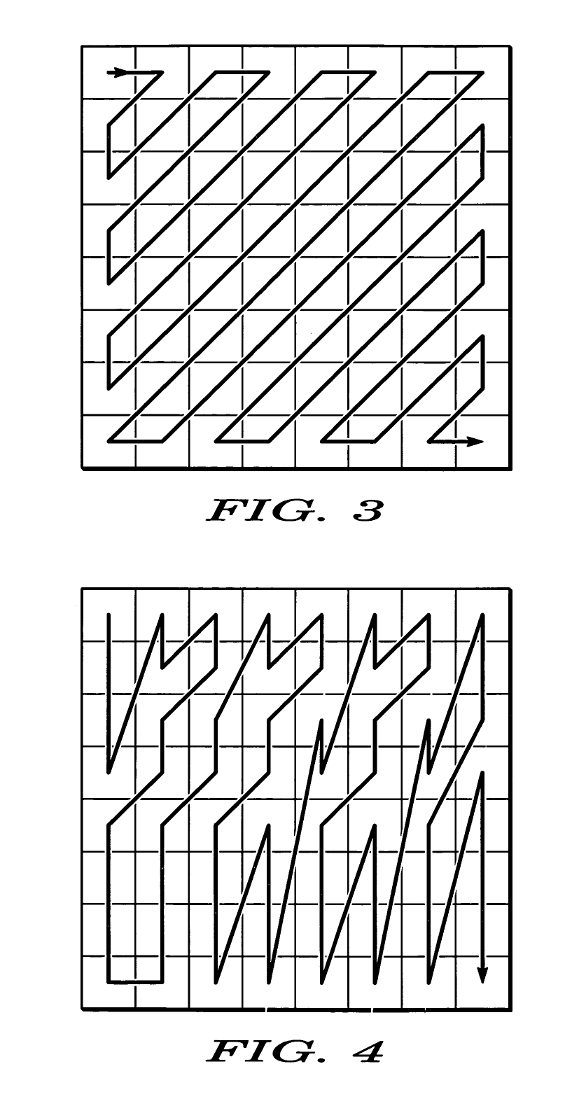

FIG. 2 depicts a block diagram of an exemplary motion compensated encoder 200 of the present invention, e.g., the compliant encoder 120 of FIG. 1. In one embodiment of the present invention, the apparatus 200 is an encoder or a portion of a more complex variable block-based motion compensation coding system. The apparatus 200 comprises a variable block motion estimation module 240, a motion compensation module 250, a rate control module 230, a discrete cosine transform (DCT) module 260, a quantization (Q) module 270, a variable length coding (VLC) module 280, a buffer (BUF) 290, an inverse quantization (Q⁻¹) module 275, an inverse DCT (DCT⁻¹) transform module 265, a subtractor 215 and a summer 255. Although the apparatus 200 comprises a plurality of modules, those skilled in the art will realize that the functions performed by the various modules are not required to be isolated into separate modules as shown in FIG. 2. For example, the set of modules comprising the motion compensation module 250, inverse quantization module 275 and inverse DCT module 265 is generally known as an “embedded decoder”.

FIG. 2 illustrates an input video image (image sequence) on path 210 which is digitized and represented as a luminance and two color difference signals (Y, Cᵣ, C_{b}) in accordance with the MPEG standards. These signals are further divided into a plurality of layers (sequence, group of pictures, picture, slice and blocks) such that each picture (frame) is represented by a plurality of blocks having different sizes. The division of a picture into block units improves the ability to discern changes between two successive pictures and improves image compression through the elimination of low amplitude transformed coefficients (discussed below). The digitized signal may optionally undergo preprocessing such as format conversion for selecting an appropriate window, resolution and input format.

The input video image on path 210 is received into variable block motion estimation module 240 for estimating motion vectors. The motion vectors from the variable block motion estimation module 240 are received by the motion compensation module 250 for improving the efficiency of the prediction of sample values. Motion compensation involves a prediction that uses motion vectors to provide offsets into the past and/or future reference frames containing previously decoded sample values that are used to form the prediction error. Namely, the motion compensation module 250 uses the previously decoded frame and the motion vectors to construct an estimate of the current frame.

Furthermore, prior to performing motion compensation prediction for a given block, a coding mode must be selected. In the area of coding mode decision, MPEG provides a plurality of different coding modes. Generally, these coding modes are grouped into two broad classifications, inter mode coding and intra mode coding. Intra mode coding involves the coding of a block or picture that uses information only from that block or picture. Conversely, inter mode coding involves the coding of a block or picture that uses information both from itself and from blocks and pictures occurring at different times. Specifically, MPEG-2 provides coding modes which include intra mode, no motion compensation mode (No MC), frame/field/dual-prime motion compensation inter mode, forward/backward/average inter mode and field/frame DCT mode. The proper selection of a coding mode for each block will improve coding performance. Again, various methods are currently available to an encoder designer for implementing coding mode decision.

Once a coding mode is selected, motion compensation module 250 generates a motion compensated prediction (predicted image) on path 252 of the contents of the block based on past and/or future reference pictures. This motion compensated prediction on path 252 is subtracted via subtractor 215 from the video image on path 210 in the current block to form an error signal or predictive residual signal on path 253. The formation of the predictive residual signal effectively removes redundant information in the input video image. Namely, instead of transmitting the actual video image via a transmission channel, only the information necessary to generate the predictions of the video image and the errors of these predictions are transmitted, thereby significantly reducing the amount of data needed to be transmitted. To further reduce the bit rate, predictive residual signal on path 253 is passed to the DCT module 260 for encoding.

The DCT module 260 then applies a forward discrete cosine transform process to each block of the predictive residual signal to produce a set of eight (8) by eight (8) blocks of DCT coefficients. The number of 8×8 blocks of DCT coefficients will depend upon the size of each block. The discrete cosine transform is an invertible, discrete orthogonal transformation where the DCT coefficients represent the amplitudes of a set of cosine basis functions. One advantage of the discrete cosine transform is that the DCT coefficients are uncorrelated. This decorrelation of the DCT coefficients is important for compression, because each coefficient can be treated independently without the loss of compression efficiency. Furthermore, the DCT basis function or subband decomposition permits effective use of psychovisual criteria which is important for the next step of quantization.

The resulting 8×8 block of DCT coefficients is received by quantization module 270 where the DCT coefficients are quantized. The process of quantization reduces the accuracy with which the DCT coefficients are represented by dividing the DCT coefficients by a set of quantization values with appropriate rounding to form integer values. The quantization values can be set individually for each DCT coefficient, using criteria based on the visibility of the basis functions (known as visually weighted quantization). Namely, the quantization value corresponds to the threshold for visibility of a given basis function, i.e., the coefficient amplitude that is just detectable by the human eye. By quantizing the DCT coefficients with this value, many of the DCT coefficients are converted to the value “zero”, thereby improving image compression efficiency. The process of quantization is a key operation and is an important tool to achieve visual quality and to control the encoder to match its output to a given bit rate (rate control). Since a different quantization value can be applied to each DCT coefficient, a “quantization matrix” is generally established as a reference table, e.g., a luminance quantization table or a chrominance quantization table. Thus, the encoder chooses a quantization matrix that determines how each frequency coefficient in the transformed block is quantized.

Next, the resulting 8×8 block of quantized DCT coefficients is received by variable length coding module 280 via signal connection 271, where the two-dimensional block of quantized coefficients is scanned using a particular scanning mode, e.g., a “zig-zag” order of FIG. 3 or an “alternative” scanning order of FIG. 4 in accordance with MPEG-2, to convert it into a one-dimensional string of quantized DCT coefficients. For example, the zig-zag scanning order is an approximate sequential ordering of the DCT coefficients from the lowest spatial frequency to the highest. Since quantization generally reduces DCT coefficients of high spatial frequencies to zero, the one-dimensional string of quantized DCT coefficients is typically represented by several integers followed by a string of zeros.

In one embodiment, the selection of the proper scanning mode in the variable length coding (VLC) module 280 is determined from information on path 107. Namely, the efficiency and/or quality for each encoded image can be easily determined based upon the result supplied by the first encoder 110 of each of the selected scanning modes, e.g., comparing the coding efficiency of odd slices with even slices. To illustrate, the second pass encoder 120 may compare the complexity (bits used) for the zigzag scan and the alternative scan pattern, and then choose the scan pattern that generates less encoding bits before the start of encoding of that frame. Thus, the information on path 107 can be effectively exploited by the second encoder to properly select the scanning mode to actually encode the image sequence.

Variable length coding (VLC) module 280 then encodes the string of quantized DCT coefficients and all side-information for the block such as block type and motion vectors. The VLC module 280 utilizes variable length coding and run-length coding to efficiently improve coding efficiency. Variable length coding is a reversible coding process where shorter code-words are assigned to frequent events and longer code-words are assigned to less frequent events, while run-length coding increases coding efficiency by encoding a run of symbols with a single symbol. These coding schemes are well known in the art and are often referred to as Huffman coding when integer-length code words are used. Thus, the VLC module 280 performs the final step of converting the input video image into a valid data stream.

The data stream is received into a “First In-First Out” (FIFO) buffer 290. A consequence of using different picture types and variable length coding is that the overall bit rate into the FIFO is variable. Namely, the number of bits used to code each frame can be different. In applications that involve a fixed-rate channel, a FIFO buffer is used to match the encoder output to the channel for smoothing the bit rate. Thus, the output signal of FIFO buffer 290 is a compressed representation of the input video image 210, where it is sent to a storage medium or telecommunication channel on path 295.

The rate control module 230 serves to monitor and adjust the bit rate of the data stream entering the FIFO buffer 290 for preventing overflow and underflow on the decoder side (within a receiver or target storage device, not shown) after transmission of the data stream. A fixed-rate channel is assumed to put bits at a constant rate into an input buffer within the decoder. At regular intervals determined by the picture rate, the decoder instantaneously removes all the bits for the next picture from its input buffer. If there are too few bits in the input buffer, i.e., all the bits for the next picture have not been received, then the input buffer underflows resulting in an error. Similarly, if there are too many bits in the input buffer, i.e., the capacity of the input buffer is exceeded between picture starts, then the input buffer overflows resulting in an overflow error. Thus, it is the task of the rate control module 230 to monitor the status of buffer 290 to control the number of bits generated by the encoder, thereby preventing the overflow and underflow conditions. Rate control algorithms play an important role in affecting image quality and compression efficiency.

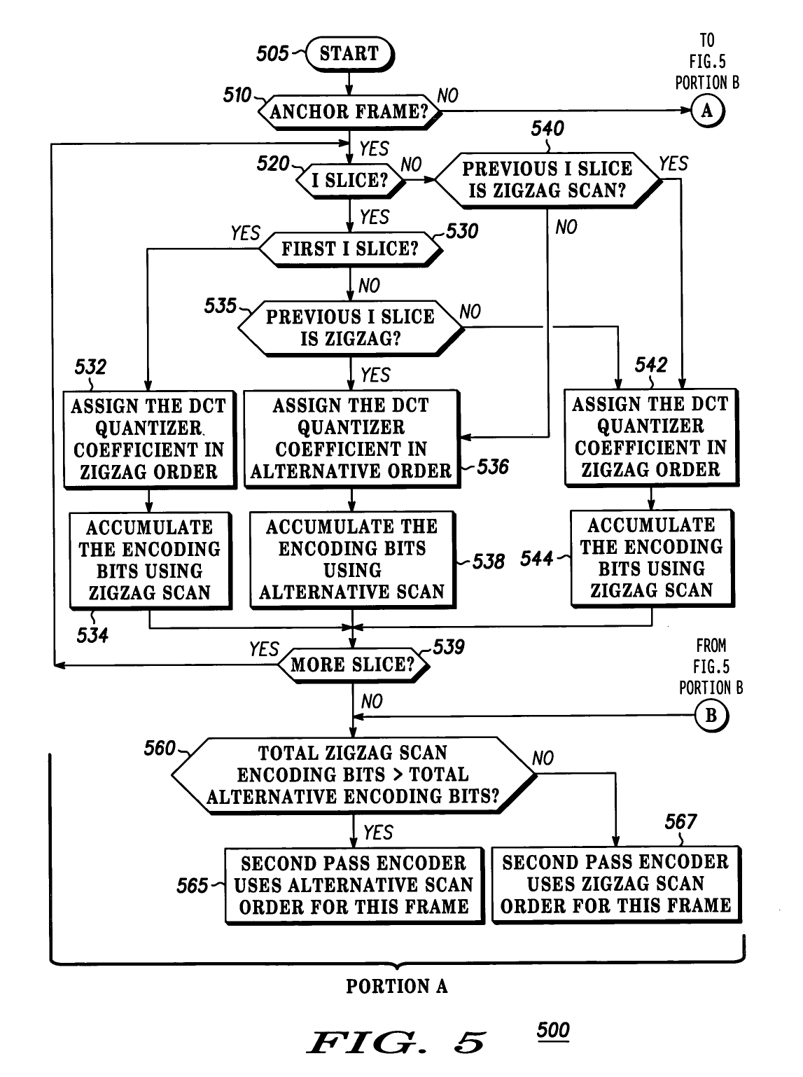

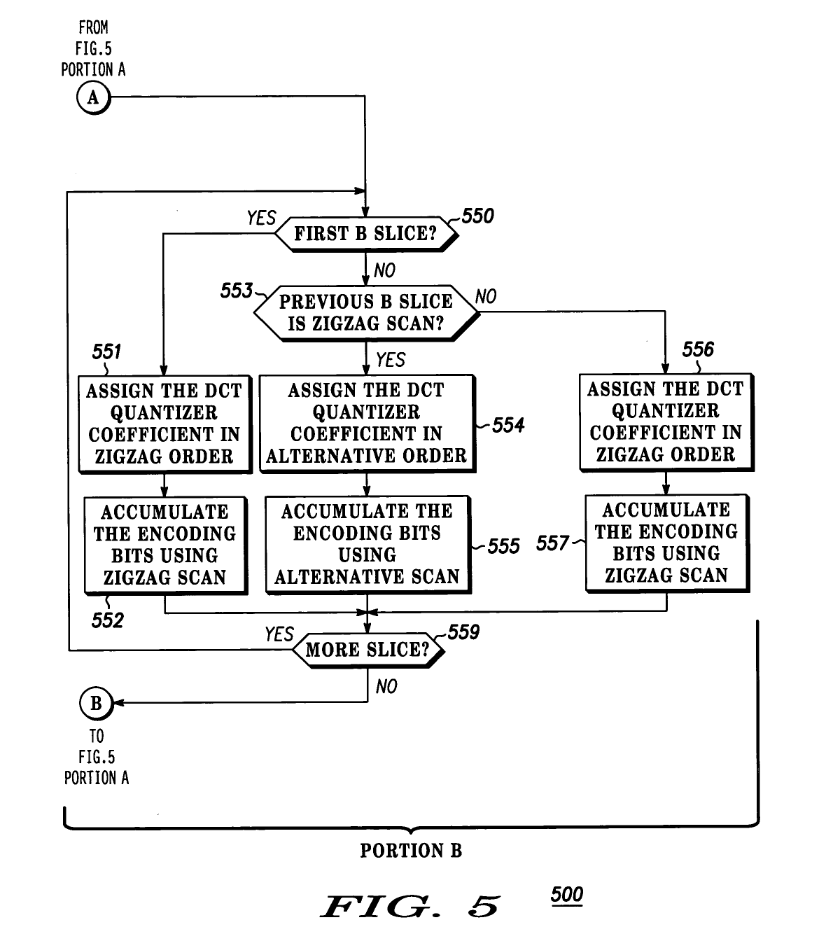

FIG. 5 illustrates a method 500 for adaptive selection of scanning modes based on the content of the input image sequence of the present invention. Specifically, in one embodiment the present invention entails a method and apparatus to choose an appropriate DCT scan pattern in MPEG-2 depending on the video content for improving video quality.

In one embodiment, the present invention encodes every anchor frame on the first pass encoder as a P frame. Alternate slices in the P frames on the first pass encoder are alternately encoded as I slices and P slices. The DCT quantized coefficients of every I and P slices pair are alternatively ordered using zigzag scan pattern and alternative scan pattern. Therefore the complexity (bits used) of both zigzag and alternative scan pattern are computed without applying the scan patterns on the same frame twice. This arrangement allows the second pass encoder to choose the scan pattern that uses fewer encoding bits.

In a dual pass encoding system, the first pass encoder computes the I and P complexity on one anchor frame once by encoding every other slice alternatively as I and P slice. The second pass encoder will take advantage of such look-ahead information to decide the picture coding type accordingly. The scan pattern has to be determined prior to the start of encoding the picture. In order not to encode the same frame twice with different scan pattern, the first pass encoder groups each neighboring I and P slice as a pair, and the DCT quantized coefficients of each I/P slice pair are alternatively ordered using zigzag or alternative scan pattern. The bits used with different scan pattern are accumulated as the reference for the second pass encoder scan pattern decision.

In case the encoding frame on first pass encoder is not an anchor frame (e.g., B frame), the DCT quantized coefficients of alternate slices in the B frames on the first pass encoder are alternately ordered using zigzag or alternative scan pattern. Thus the bits used with either scan pattern are computed without encoding the same frame twice. The bits used with different scan patterns are accumulated as the reference for the second pass encoder scan pattern decision. One example of the above described method for adaptively selecting a scan mode for each picture in an image sequence is now described with reference to FIG. 5.

Method 500 starts in step 505 and proceeds to step 510 where a frame or picture is received by the first encoder. In step 510, method 500 queries whether the received frame is an anchor frame. If the query is positively answered, then method 500 proceeds to step 520. If the query is negatively answered, then method 500 proceeds to step 550.

In step 520, method 500 queries whether a current slice is an I slice. If the query is positively answered, then method 500 proceeds to step 530. If the query is negatively answered (e.g., a current slice is a P slice), then method 500 proceeds to step 540.

In step 530, method 500 queries whether the I slice is a first I slice. If the query is positively answered, then method 500 proceeds to step 532. If the query is negatively answered, then method 500 proceeds to step 535.

In step 532, method 500 assigns the DCT quantized coefficients in zigzag order. In turn, method 500 in step 534 accumulates the encoding bits using the zigzag scan.

In step 535, method 500 queries whether a previous I slice is in zigzag order. If the query is positively answered, then method 500 proceeds to step 536. If the query is negatively answered, then method 500 proceeds to step 542.

In step 536, method 500 assigns the DCT quantized coefficients in alternative order. In turn, method 500 in step 538 accumulates the encoding bits using the alternative scan.

In step 542, method 500 assigns the DCT quantized coefficients in zigzag order. In turn, method 500 in step 544 accumulates the encoding bits using the zigzag scan.

In step 539, method 500 queries whether there is another slice in the frame that needs to be encoded. If the query is positively answered, then method 500 returns to step 520 where the various steps are repeated until the entire frame is processed. If the query is negatively answered, then method 500 proceeds to step 560.

In step 550, method 500 queries whether the B slice is a first B slice. If the query is positively answered, then method 500 proceeds to step 551. If the query is negatively answered, then method 500 proceeds to step 553.

In step 551, method 500 assigns the DCT quantized coefficients in zigzag order. In turn, method 500 in step 552 accumulates the encoding bits using the zigzag scan.

In step 553, method 500 queries whether a previous B slice is in zigzag order. If the query is positively answered, then method 500 proceeds to step 554. If the query is negatively answered, then method 500 proceeds to step 556.

In step 554, method 500 assigns the DCT quantized coefficients in alternative scan order. In turn, method 500 in step 555 accumulates the encoding bits using the alternative scan.

In step 556, method 500 assigns the DCT quantized coefficients in zigzag order. In turn, method 500 in step 557 accumulates the encoding bits using the zigzag scan.

In step 559, method 500 queries whether there is another slice in the frame that needs to be encoded. If the query is positively answered, then method 500 returns to step 550 where the various steps are repeated until the entire frame is processed. If the query is negatively answered, then method 500 proceeds to step 560.

In step 560, method 500 queries whether the total zigzag scan coding bits are greater than the total alternative scan coding bits. If the query is positively answered, then method 500 proceeds to step 565 where information is sent to the second encoder informing the second encoder to select the alternative scanning mode for the current picture. If the query is negatively answered, then method 500 proceeds to step 567 where information is sent to the second encoder informing the second encoder to select the zigzag scanning mode for the current picture.

Although the present invention is described above in terms of encoding alternate slices of a frame in different scanning modes, the present invention is not so limited. Alternatively, every other macroblock in the first pass encoder may be encoded in zigzag and alternative DCT scan order, and the bits used for zigzag and alternative scan order are similarly accumulated and used for second pass encoder scan pattern decision. In fact, any alternate “portion” of the frame can be used, where the size of the portion (e.g., a group of slices, a slice, a macroblock, a subblock and so on) can be selected based upon application requirements.

Alternatively, a checker board pattern of zigzag scan and alternate scan macroblock may also be used in the first pass encoder.

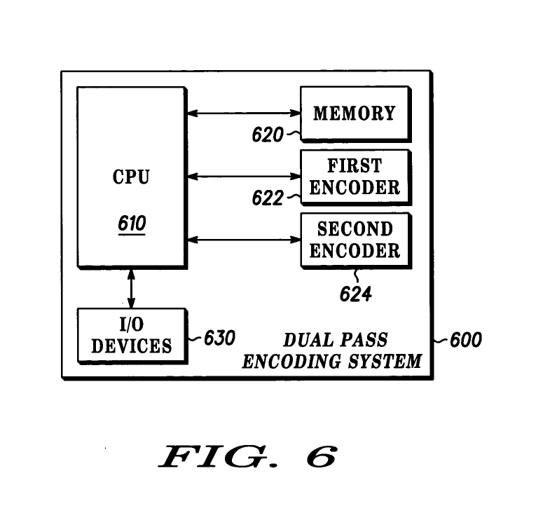

FIG. 6 is a block diagram of the present dual pass encoding system being implemented with a general purpose computer. In one embodiment, the dual pass encoding system 600 is implemented using a general purpose computer or any other hardware equivalents. More specifically, the dual pass encoding system 600 comprises a processor (CPU) 610, a memory 620, e.g., random access memory (RAM) and/or read only memory (ROM), a first encoder 622, a second encoder 624, and various input/output devices 630 (e.g., storage devices, including but not limited to, a tape drive, a floppy drive, a hard disk drive or a compact disk drive, a receiver, a transmitter, a speaker, a display, an output port, a user input device (such as a keyboard, a keypad, a mouse, and the like), or a microphone for capturing speech commands).

It should be understood that the first encoder 622 and the second encoder 624 can be implemented as physical devices or subsystems that are coupled to the CPU 610 through a communication channel. Alternatively, the first encoder 622 and the second encoder 624 can be represented by one or more software applications (or even a combination of software and hardware, e.g., using application specific integrated circuits (ASIC)), where the software is loaded from a storage medium (e.g., a magnetic or optical drive or diskette) and operated by the CPU in the memory 620 of the computer. As such, the first encoder 622 and the second encoder 624 (including associated data structures) of the present invention can be stored on a computer readable medium or carrier, e.g., RAM memory, magnetic or optical drive or diskette and the like.

While the foregoing is directed to embodiments of the present invention, other and further embodiments of the invention may be devised without departing from the basic scope thereof, and the scope thereof is determined by the claims that follow.

1. A method for selecting a scanning mode for a picture in an image sequence, comprising:
encoding the picture in a first encoder using at least two scanning modes;
determining coding efficiency information on said at least two scanning modes; and
selecting one of said at least two scanning modes for encoding the picture in a second encoder based upon said coding efficiency information.

2. The method of claim 1, wherein said second encoder is a compliant encoder in accordance with a compression standard.

3. The method of claim 2, wherein said compression standard is Moving Picture Experts Group (MPEG)-2.

4. The method of claim 1, wherein said at least two scanning modes comprise a zigzag scan mode and an alternative mode.

5. The method of claim 1, wherein the picture is divided into portions, where different portions are coded using different scanning modes from said at least two scanning modes.

6. The method of claim 5, wherein said portions comprises at least one of slices, macroblocks and subblocks.

7. The method of claim 6, where if the picture is an anchor frame, then different portions of the picture are encoded as alternating I portions or P portions.

8. The method of claim 7, wherein said I portions are I slices and said P portions are P slices.

9. The method of claim 8, where said alternating I slices and P slices are grouped into I and P slice pairs, where said I and P slice pairs are alternately encoded using said at least two scanning modes.

10. An apparatus for selecting a scanning mode for a picture in an image sequence, comprising:
a first encoder for encoding the picture using at least two scanning modes; and
a second encoder for selecting one of said at least two scanning modes for encoding the picture based upon coding efficiency information on said at least two scanning modes received from said first encoder.

11. The apparatus of claim 1, wherein said second encoder is a compliant encoder in accordance with a compression standard.

12. The apparatus of claim 11, wherein said compression standard is Moving Picture Experts Group (MPEG)-2.

13. The apparatus of claim 10, wherein said at least two scanning modes comprise a zigzag scan mode and an alternative mode.

14. The apparatus of claim 10, wherein the picture is divided into portions, where different portions are coded using different scanning modes from said at least two scanning modes.

15. The apparatus of claim 5, wherein said portions comprises at least one of slices, macroblocks and subblocks.

16. The apparatus of claim 15, where if the picture is an anchor frame, then different portions of the picture are encoded as alternating I portions or P portions.

17. The apparatus of claim 16, wherein said I portions are I slices and said P portions are P slices.

18. The apparatus of claim 17, where said alternating I slices and P slices are grouped into I and P slice pairs, where said I and P slice pairs are alternately encoded using said at least two scanning modes.

19. A computer-readable carrier having stored thereon a plurality of instructions, the plurality of instructions including instructions which, when executed by a processor, cause the processor to perform the steps of a method for selecting a scanning mode for a picture in an image sequence, comprising of:
encoding the picture in a first encoder using at least two scanning modes;
determining coding efficiency information on said at least two scanning modes; and
selecting one of said at least two scanning modes for encoding the picture in a second encoder based upon said coding efficiency information.

20. The computer-readable carrier of claim 19, wherein said second encoder is a compliant encoder in accordance with a compression standard.

21. The computer-readable carrier of claim 20, wherein said compression standard is Moving Picture Experts Group (MPEG)-2.

22. The computer-readable carrier of claim 19, wherein said at least two scanning modes comprise a zigzag scan mode and an alternative mode.

23. The computer-readable carrier of claim 19, wherein the picture is divided into portions, where different portions are coded using different scanning modes from said at least two scanning modes.

24. The computer-readable carrier of claim 23, wherein said portions comprises at least one of slices, macroblocks and subblocks.

25. The computer-readable carrier of claim 24, where if the picture is an anchor frame, then different portions of the picture are encoded as alternating I portions or P portions.

26. The computer-readable carrier of claim 25, wherein said I portions are I slices and said P portions are P slices.

27. The computer-readable carrier of claim 26, where said alternating I slices and P slices are grouped into I and P slice pairs, where said I and P slice pairs are alternately encoded using said at least two scanning modes.
